(19) United States
(12) Patent Application Publication
(10) Pub. No.: US 2013/0313173 A1
(43) Pub. Date: Nov. 28, 2013

(54) Device for Treating Water Comprising a Solid Filter Drum

(71) Applicants: Thomas Schmitt, Trevignin (FR); Nikolai Hertfelder, Kirchberg (DE)

(72) Inventors: Thomas Schmitt, Trevignin (FR); Nikolai Hertfelder, Kirchberg (DE)

(21) Appl. No.: 13/808,011

(22) PCT Filed: Jun. 30, 2011
(86) PCT No.: PCT/EP2011/061079

§ 371 Date: Aug. 5, 2013

(30) Foreign Application Priority Data
Jul. 2, 2010 (FR) 1055348

(51) Int. Cl. C02F 3/00

(52) U.S. Cl. CPC C02F 3/00
USPC 210/151

(57) ABSTRACT

Device for treating water comprising a solid filter drum. The invention relates to a device for treating water comprising:—a biological treatment zone (13) housing a plurality of biological discs (16) mounted on a shaft (17) that can be turned, —a filtration zone (14) housing a filter drum (20) mounted on the same shaft as the said biological discs (16), —conveying means (39) for conveying biologically treated water originating from said biological treatment zone (13) into said filter drum (20), —means for unplugging said filter drum (20), which means are positioned on the outside of said filter drum (20), —sludge collection means (24) positioned inside said filter drum (20) facing said unplugging means and connected to a discharge line (28, 29, 30) that discharges said sludge from said filter drum (20). According to the invention, the sides of said filter drum (20) are closed by solid sidewalls (22, 23), and said discharge line (28, 29, 30) comprises a portion (30) which extends along the axis of said shaft (17) through a first of said sidewalls (23) mounted to rotate about said axis, the second sidewall (22) of said filter drum (20) being secured to said shaft (17).

### 1. FIELD OF THE INVENTION

The field of the invention is that of plants implemented to carry out the biological treatment of wastewater.

More specifically, the invention pertains to a plant for treating water comprising a biological treatment zone housing biological disks followed by a filtering zone housing a filter drum.

### 2. PRIOR ART

The French patent application number FR-A1-2 916 436 filed by the present Applicant, describes such a plant.

More specifically, such a plant comprises a biological treatment zone housing a plurality of biological disks mounted on a shaft capable of being driven in rotation.

A raw water is conveyed into this zone so as to be treated biologically in contact with the biological disks.

This biological treatment zone is followed by a filtering zone housing a filter drum mounted in the same axis as said biological disks. A piping enables the conveyance by gravity of a biologically treated water coming from the biological treatment zone into the filter drum.

One side of the filter drum is fixedly joined to the axis on which the biological disks are mounted. The other side is provided with a rail attached to the filter drum with which there cooperate four rollers fixedly joined to the frame of the plant. The filter drum can thus be driven in rotation by the axis of the biological disks so as to filter the water coming from the biological treatment zone.

The sludges coming from this filtration are retained on the inner surface of the filter drum while filtered water flows through the filter drum towards the bottom of this filtering zone.

An injection bar placed outside the filter drum is used to inject water and/or air onto the surface of the filter drum in order to unclog it. A chute is placed inside the filter drum facing the injection bar in order to collect the sludges coming from the unclogging process. A piping connected to the chute is used to discharge the sludges outside the filter drum.

Such an installation is advantageous in that it enables the efficient processing, in a compact space, of the wastewater from small-sized and medium-sized communities comprising for example 100 to 10,000 inhabitants. Its implementation nevertheless has some drawbacks.

### 3. DRAWBACKS OF THE PRIOR ART

In particular, the two sides of the filter drum are open. Thus, when such a plant is implemented, biologically treated water can be seen to splash out of the filter drum.

The biologically treated water which gets splashed outside the filter drum falls in part directly into the bottom of the filtering zone. The filtered water collected at the bottom of this filtering zone can thus get mixed with the biologically treated but non-filtered water, and this would tend to diminish its quality.

Another part of the biologically treated water splashed outside the filter drum drips onto the guide rail of the filter drum as well as onto the rollers that cooperate with it. These elements then tend, on the one hand, to get clogged and oxidized. On the other hand, a premature wearing out is observed in these means for the rotational guiding of the filter drum. Regular operations therefore need to be carried out to clean the rail and replace the rollers. These maintenance operations also dictate the stopping of the treatment of water. The maintenance of such a plant represents a heavy cost item and leads to a drop in productivity. In certain rare cases, in particular when the users do not carry out these maintenance campaigns regularly and stringently, the rollers may break, inducing damages that are more consequential, especially the stoppage of the plant. Such stoppage can lead to non-treated wastewater being shed into the natural environment. It can also give rise to a non-uniform growth of microorganisms on the surface of the biological disks, these microorganisms tending indeed to show higher growth on the immersed portion of the biological disks than on their emerged portion. This leads to a phenomenon of imbalance when the plant is put back into operation.

Another drawback of this prior-art technique is related to the fact that the chute placed inside the filter drum to collect the sludges coming from the unclogging of the filter drum is mounted fixedly inside this drum. However, the dimensional tolerance values of this type of plant are relatively wide. It can thus happen that, after the plant has been assembled, the chute is not perfectly facing the injection bar placed outside the filter drum. Thus, during the unclogging, only a part of the sludges released from the filter drum are discharged outside it. The rest of the sludges thus released partly fall directly onto the inner surface of the filter drum and are partly thrown out of the filter drum, with the consequences referred to further above.

### 4. GOALS OF THE INVENTION

The invention therefore is aimed especially at overcoming these drawbacks of the prior art.

More specifically, it is a goal of the invention, in at least one embodiment, to provide a plant for treating water comprising biological disks followed by a filter drum, the implementation of which requires few maintenance campaigns.

In particular, the invention, in at least one embodiment, pursues the goal of providing a technique of this kind that is robust.

It is another goal of the invention, in at least one embodiment, to implement a technique of this kind which, as compared with the prior-art technique, improves the quality of the treated water produced.

It is yet another goal of the invention, in at least one embodiment, to provide a technique of this kind that optimizes the unclogging of the filter drum.

In this sense, the invention is aimed especially, in at least one embodiment, at increasing the quality of sludges collected during the unclogging of the filter drum so as to discharge them out of this drum.

It is yet another goal of the invention in at least one embodiment to provide a technique of this kind that is simple and economical to implement.

### 5. SUMMARY OF THE INVENTION

These goals, as well as others that shall appear here below, are achieved by means of a device for treating water comprising:
a biological treatment zone housing a plurality of biological disks mounted on a shaft capable of being driven in rotation,
a filtering zone housing a filter drum mounted on the same axis as said biological disks,
means for conveying a biologically treated water coming from said biological treatment zone into said filter drum,
means for unclogging said filter drum placed outside said filter drum,
means for collecting sludges placed inside said filter drum facing said unclogging means and connected to a piping for discharging said sludges outside said filter drum.

According to the invention, the sides of said filter drum are closed by solid sidewalls and said piping for discharging comprise a portion that extends in the axis of said shaft through a first of said sidewalls mounted in rotation around this axis, the second sidewall of said filter drum being fixedly joined to said shaft.

Thus, the invention relies on a wholly original approach which consists in implementing a filter drum, the sides of which are closed by solid sidewalls, one of these sidewalls being fixedly joined to the shaft on which the biological disks are mounted, the other being crossed at its center by the piping for discharging sludges coming from the unclogging and on which it is guided in rotation.

Since the sides of the filter drum are closed, no splashing out of the filter drum of water that is only biologically treated and of sludge from the unclogging can be seen.

Thus, this implementation makes it possible especially to:
prevent rapid deterioration of the means for rotational guiding of the filter drum;
reduce the frequency of implementation of the maintenance operations;
increase productivity;
improve the quality of the treated water produced.

According to a preferred embodiment, said first sidewall of a filter drum of a device according to the invention is mounted so as to be mobile in rotation about said portion of piping for discharging by means of a sealed bearing.

This implementation further makes it possible to further extend the service life of the means for guiding the filter drum in rotation and therefore reduces the frequency of implementation of the operations necessary for its maintenance.

In this case, said sealed bearing advantageously comprises at least one roller-bearing element and two half-shells, said two half-shells defining a housing for said at least one roller-bearing element.

It is thus possible to easily access the roller-bearing element placed inside the two half-shells to carry out its maintenance in a simple manner.

Also in this case, said half-shells are preferably made out of plastic.

Such half-shells can also be obtained in a simple and economical way while at the same time withstanding corrosion and being very light.

According to a preferred characteristic, a device according to the invention comprises means for introducing a fresh lubricant into said sealed bearing.

In this case, it also advantageously comprises means for discharging a used lubricant from the interior of said sealed bearing.

It is thus possible to easily replace the lubricant substance introduced into the bearing in order to ensure its service life.

According to a preferred embodiment, said means for collecting sludges from a device according to the invention are mounted so as to be mobile in rotation about said axis facing the inner surface of said filter drum.

Thus, during the assembling of a device according to the invention, it is possible to adjust the position of the means for collecting sludges relatively to the unclogging means so that they are placed perfectly facing one another. Thus, the quantity of sludges collected and extracted from the filter drum during the unclogging is maximized.

In this case, said means for collecting sludges preferably comprise a chute, said chute being connected to said piping portion by means of an arm, one end of which is fixedly joined to said chute, and the other end of which is mounted so as to be mobile in rotation on said piping portion.

Such an architecture is simple in its design but efficient and particularly robust.

According to an advantageous characteristic, said chute is flush with the inner surface of said filter drum.

This also plays a role in maximizing the quantity of sludges collected and extracted from the filter drum during the unclogging.

According to another advantageous characteristic, said chute has a “V”-shaped section, the inlet of said piping for discharging opening into the bottom of said “V”.

This implementation facilitates the discharge of the sludges outside the chute and prevents the chute from overflowing during the unclogging of the filter drum.

### 6. LIST OF FIGURES

Other features and advantages of the invention shall appear more clearly from the following description of a preferred embodiment given by way of a simple, illustratory and non-exhaustive example and from the appended drawings, of which:

FIG. 1 illustrates a side view of an example of a device for treating water according to the invention;

FIG. 2 illustrates a detailed view of the filtering zone of the device for treating water shown in FIG. 1;

FIG. 3 illustrates a section of two half-shells according to the invention.

### 7. DESCRIPTION OF ONE EMBODIMENT OF THE INVENTION

7.1. Reminder of the principle of the invention

The general principle of the invention relies on the implementation of a filter drum, the sides of which are closed by solid sidewalls. One of its sidewalls is fixedly joined to a shaft placed upstream on which there are mounted biological disks. The other sidewall is crossed at its center by the piping for discharging sludges that come from the unclogging, and is guided on it in rotation.

Such an implementation prevents the splashing out of the filter drum of water treated only biologically and of sludges coming from the unclogging and therefore:
prevents rapid deterioration of the means for guiding the filter drum in rotation;
reduces the frequency of implementation of maintenance operations;
increases productivity;
improves the quality of the treated water produced.

7.2. Example of a device for treating water according to the invention

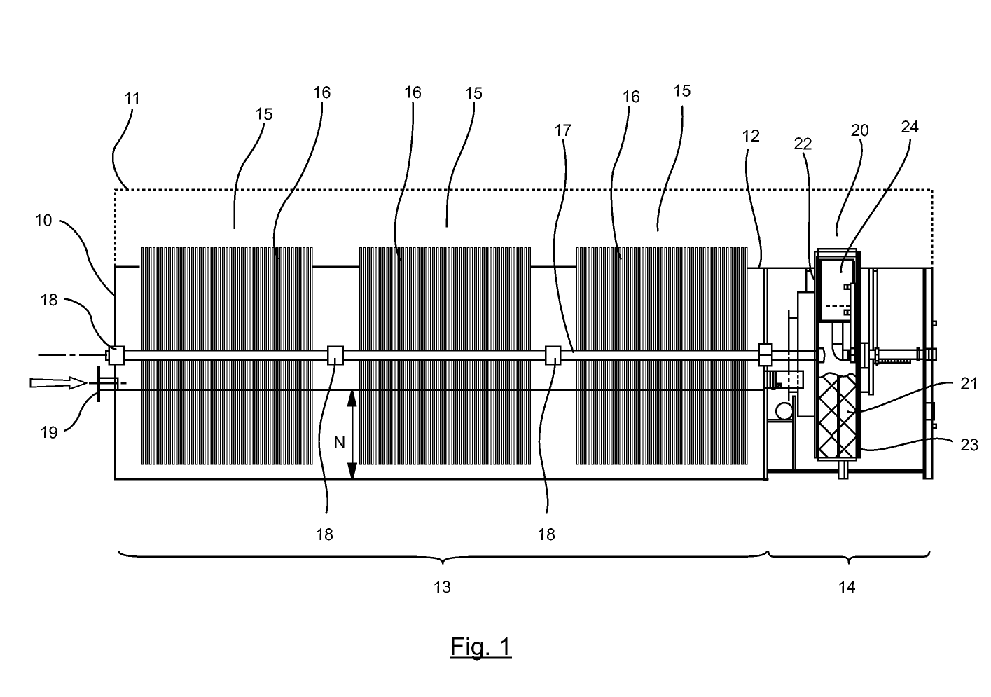

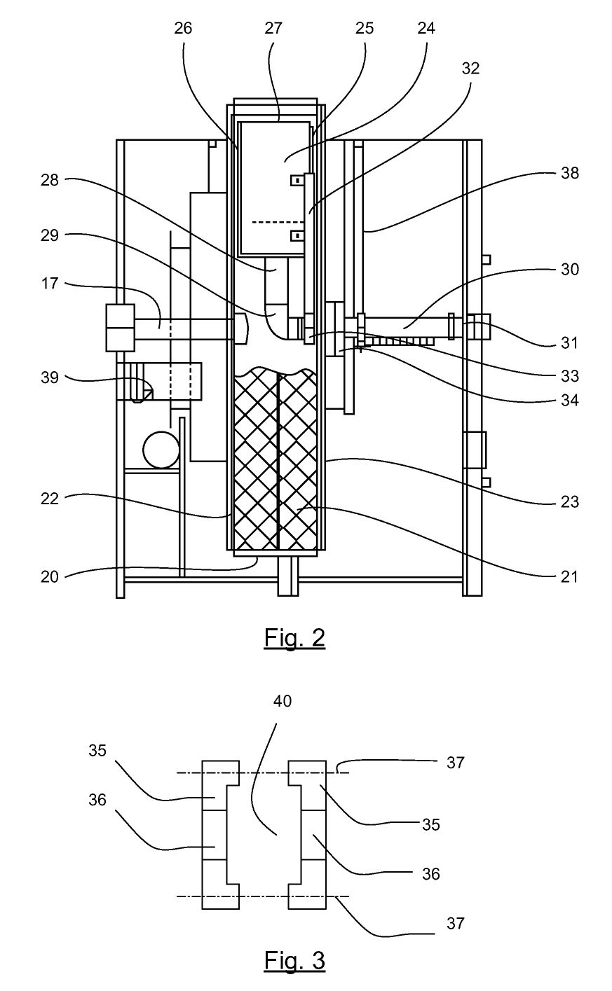

Referring to FIGS. 1 and 2, we present an embodiment of a device for treating water according to the invention.

As can be seen in FIGS. 1 and 2, such a device for treating water comprises an essentially parallelepiped-shaped tank 10 closed at its upper part by a detachable lid 11. This tank 10 houses a vertical wall 12 which therein demarcates a biological treatment zone 13 and a filtering zone 14.

The biological treatment zone 13 houses batches 15 of a plurality of biological disks 16.

The biological disks 16 are mounted on a shaft 17 guided in rotation relatively to the tank 10 of the device by means of bearings 18.

The shaft 17 can be driven in rotation about its axis by means of a motor not shown.

A piping for the inlet of water to be treated 19 opens into the biological treatment zone 13.

The filtering zone 14 houses a filter drum 20. The circumference of this filter drum 20 comprises a screen 21. The filter drum 20 extends in the same axis as the biological disks 16. Its sides are closed by solid sidewalls 22, 23.

A piping 39 is used to convey water coming from the biological treatment zone 13 into the filter drum 20.

Means for unclogging the filter drum 20, not shown, comprise an injection bar for injecting air and/or water. This injection bar extends from the exterior of the filter drum 20 throughout its width, in proximity to its external surface and parallel to its axis.

Means for collecting sludges, which in this embodiment comprise a chute 24, are housed in the filter drum 20.

This chute 24 has a “V”-shaped section. Its side faces 25, 26 are flush with the sidewalls 22, 23 of the filter drum 20. The surface demarcated by its upper outline 27 is flush with the inner surface of the screen 21.

Discharging means are used to discharge the content of the chute 24 out of the filter drum 20. These discharging means comprise a first portion of piping for discharging 28 which cooperates with the outlet of the chute 24 made at the bottom of the “V” and extends in the direction of the axis of the filter drum 20 to open into an elbow 29. This elbow 29 opens into a second portion of piping for discharging 30 which extends in the axis of the shaft 17 and leads out to the exterior of the tank 10.

The second piping portion 30 is fixedly joined in the region of its outlet 31 to the wall of the tank 10. It is held upstream by means of a bar 38, the lower end of which is fixedly joined to the second piping portion 30 and the upper end of which is fixedly joined to the tank 10 of the device.

The chute 24 is connected to one end of an arm 32. The other end of this arm 32 is joined in rotation to the second piping portion 30 by means of a clamping element 33.

The clamping element 33 can be temporarily loosened by an operator to enable him to cause the chute 24 to rotate around the second piping portion 30 in order to adjust the position of the chute 24 relatively to the bar. Once the chute 24 is positioned inside the filter drum 20 so that it is facing the bar, the operator can re-tighten the clamping element 33 so as to hold the chute 24 in position.

The solid sidewall 22, which is turned towards the biological treatment zone 13, is fixedly joined at its centre to the end of the shaft 17.

The solid sidewall 23 is crossed at its centre by a slot through which there passes the second piping portion 30. It is mounted in rotation about this second piping portion 30 by means of a bearing 34.

The putting of the shaft 17 into rotation by means of the motor thus enables the biological disks 16 and the filter drum 20 to be driven in rotation.

In this embodiment, the bearing 34 is a sealed bearing. It comprises two half-shells 35.

Each half-shell 35 has a cylindrical external outline and, as shown in FIG. 3, a U-shaped section. It is crossed at its centre by an aperture 36 and at its periphery by a plurality of perforations 37 distributed uniformly along a circle that is concentric with said half-shells 35. The two half-shells 35 are made out of polypropylene. In variants, other suitable materials could be implemented. The two half-shells 35 are designed to be fixedly joined to each other to form a tightly-sealed inner housing 40 capable of receiving a roller-bearing element such as for example double-row spherical roller bearings (not shown). The apertures 36 enable the passage of the second piping portion 30.

The bearing 34 is assembled as follows. A roller-bearing element (not shown) is housed in a half-shell 35. A second half-shell 35 is attached to the first one, a seal that is not shown being interposed between these two elements. The bearing 34 is then fixedly joined to the sidewall 23 of the filter drum 20 by means of screws passing through the perforations 37 and cooperating with nuts fixedly joined to the sidewall 23.

The bearing 34 comprises means for introducing a fresh lubricant into the housing 40 in which there is placed the roller element. In this embodiment, these means for introducing comprise a grease dispenser (not shown) which can be made by an operator to cooperate with a grease pump. The greasing is preferably done before the device is first put into service and then once a year (annual maintenance). The bearing 34 also has means for discharging a used lubricant present in this housing 40. In this embodiment, they comprise a screw that is screwed into a housing of complementary shape opening into the housing 40 in which the roller element is situated, a seal being interposed between the head of the screw and the half-bearing 35 in which it is housed.

1-10. (canceled)

11. A device for treating water comprising:
a biological treatment zone, wherein the biological treatment zone houses a plurality of biological disks mounted on a shaft capable of being rotatively driven;
a filtering zone wherein the filtering zone houses a filter drum mounted on the shaft;
means for conveying a biologically treated water from the biological treatment zone into the filter drum;
means for collecting sludges, wherein the means for collecting sludges is placed inside the filter drum facing the unclogging means and connected to a piping for discharging sludges from the filter drum;
wherein the sides of the filter drum are closed by at least a first sidewall and a second sidewall, and wherein the piping for discharging comprises a portion that extends in an axis of the shaft through the first sidewall mounted for rotation around the axis, and wherein the second sidewall of the filter drum is fixedly joined to the shaft.

12. The device according to claim 11, characterized in that the first sidewall is mounted so as to be mobile in rotation about the portion of the piping for discharging by a sealed bearing.

13. The device according to claim 12, characterized in that the sealed bearing comprises two half-shells and at least one roller-bearing element, wherein the two half-shells define a housing for the at least one roller-bearing element.

14. The device according to claim 13, characterized in that the half-shells are made out of plastic.

15. The device according to claim 2, further comprising means for introducing a fresh lubricant into the sealed bearing.

16. The device according to claim 15, wherein the sealed bearing comprises an interior and wherein the device further comprises means for discharging a used lubricant from the interior of the sealed bearing.

17. The device according to claim 11, wherein the filter drum comprises an inner surface and wherein the means for collecting sludges is mounted so as to be mobile in rotation about the axis and to face the inner surface of the filter drum.

18. The device according to claim 17, characterized in that the means for collecting sludges comprises a chute, the chute being connected to the piping portion by means of an arm, wherein the arm comprises a first end and a second end, and wherein the first end is fixedly joined to the chute and the second end is mounted so that the arm is mobile in rotation on the piping portion.

19. The device according to claim 17, characterized in that the chute is flush with the inner surface of the filter drum.

20. The device according to claim 17, wherein the chute has a “V”-shaped section, and wherein the piping for discharging comprises an inlet, the inlet of the piping for discharging opening into the bottom of the “V”-shaped section.

21. A water treatment device comprising:
a biological treatment zone;
a longitudinal shaft extending generally horizontally through at least a portion of the biological treatment zone;
a plurality of biological discs mounted on the shaft;
a filter zone disposed downstream of the biological treatment zone;
a filter drum mounted in the filter zone for receiving treated water from the biological treatment zone and for filtering the water resulting in sludge being retained in the filter drum;
a sludge collection device disposed in the filter drum for collecting sludge;
the filter drum being closed by opposed first and second side walls, wherein the second side wall is fixed to the shaft such that the filter drum is rotated with the shaft and the biological discs;
sludge discharge piping operatively connected to the sludge collection device for directing sludge from the filter drum to an area exteriorly of the filter drum;
the sludge discharge piping including a generally horizontal pipe section that extends through an opening in the first side wall of the filter drum and wherein the horizontal pipe section is disposed in axial alignment with the shaft and wherein when the shaft rotates, the first side wall of the filter drum rotates around the horizontal pipe section.

22. The device of claim 21 wherein there is provided a sealed bearing between the horizontal pipe section and the opening in the first side wall which enables the first side wall to rotate around the horizontal pipe section.

23. The device of claim 22 wherein the sealed bearing comprises two half shells that define a housing.

24. The device of claim 22 wherein the first and second side walls are solid and closed.

25. The device of claim 21 wherein the filter drum is supported, in part at least, by the horizontal pipe section that forms a part of the sludge discharge piping.

26. The device of claim 21 wherein the filter drum is supported on one side by the shaft and is supported on the other side by the horizontal pipe section extending through the first side wall and wherein the first side wall is rotatably mounted on the horizontal pipe section.

27. The device of claim 21 wherein the sludge collection device is generally fixably secured in an upper portion of the filter drum by a support structure that is, in turn, supported on the sludge discharge piping, and wherein the position of the sludge collection device is radially adjustable in the filter drum.

28. The device of claim 21 wherein the sludge collection device is supported by the sludge discharge piping.

29. The device of claim 28 wherein there is provided a support structure for supporting the sludge collection device and wherein the support structure is supported on the horizontal pipe section that forms a part of the sludge discharge piping.
